(19) United States
(12) Patent Application Publication
(10) Pub. No.: US 2026/0023887 A1
(43) Pub. Date: Jan. 22, 2026

(54) BROADBAND INTRUSION DETECTION SYSTEM

(71) Applicant: Battelle Memorial Institute, Columbus, OH (US)

(72) Inventors: Raymond SPRUNGLE, Lewis Center, OH (US); Jeremiah J. SCHLEY, Dublin, OH (US); Douglas A. THORNTON, Columbus, OH (US); Mark LUST, Columbus, OH (US)

(21) Appl. No.: 19/273,819

(22) Filed: Jul. 18, 2025

Related U.S. Application Data
(60) Provisional application No. 63/672,945, filed on Jul. 18, 2024.

(51) Int. Cl. G06F 21/88; G06F 21/86; H01Q 15/00

(52) U.S. Cl. CPC G06F 21/88; G06F 21/86; H01Q 15/0013

(57) ABSTRACT

The present disclosure provides a broadband intrusion detection system for volume and asset protection. The system includes an inner cover member attached to a base unit, the inner cover member defining a protected volume between the inner cover member and the base unit; an outer cover member disposed over, and spaced-apart from, the inner cover member, and attached to the base unit; wherein a space between the inner cover member and the outer cover member defines a radio frequency (RF) waveguide. The system is configured to determine an initial RF response of the RF waveguide and to determine at least one run-time RF response of the RF waveguide; wherein a difference between the initial RF response of the RF waveguide to the at least one run-time RF response is indicative of an intrusion event into the inner and/or outer cover members.

### CROSS-REFERENCE TO RELATED APPLICATIONS

The present application claims the benefit of U.S. Provisional Appln. Ser. No. 63/672,945, filed Jul. 18, 2024, which is hereby incorporated by reference in its entirety.

### TECHNICAL FIELD

The present disclosure is generally directed to a broadband intrusion detection system for volume and asset protection.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates a broadband intrusion detection system 100 according to embodiments of the present disclosure;

FIG. 2A illustrates an assembled view of an intrusion detection system cover according to one embodiment of the present disclosure;

FIG. 2B illustrates a cross-sectional view of the intrusion detection system of FIG. 2A;

FIGS. 3A-3D illustrate example output power simulations of a waveguide structure and intrusion event according to one embodiment of the present disclosure;

FIGS. 4A-4E illustrate example simulations of a waveguide structure and intrusion event according to another embodiment of the present disclosure;

FIG. 5 illustrates an inner cover member defining an example waveguide according to another embodiment; and

FIG. 6 illustrates an inner cover member defining an example waveguide according to another embodiment.

Although the following Detailed Description will proceed with reference being made to illustrative embodiments, many alternatives, modifications and variations thereof will be apparent to those skilled in the art.

### DETAILED DESCRIPTION

The present disclosure provides a broadband intrusion detection system for volume and asset protection. The system includes a housing structure formed of inner and outer cover members. The cover members are disposed on, for example, a PC board, etc. An asset volume is defined between the inner cover and the PC board, within which one or more assets (e.g., integrated circuit (IC) assets, etc.) are disposed. A waveguide is defined between the inner and outer cover members. Radio frequency (RF) generation circuitry is configured to generate an RF signal into the waveguide, and detection circuitry is configured to detect the RF signal in the waveguide. Depending on the geometry and/or features of the waveguide, the RF response of the waveguide provides an original “signature” of the cover members, where the RF signature may be established at time of manufacture of the cover members. Intrusion into the cover members may cause a disruption of the RF response of the waveguide. The detection circuitry is generally configured to compare the original RF signature of the waveguide to run time RF signals of the waveguide, and differences between the original RF signature and run time RF signals may be used to indicate an intrusion event. In some embodiments, one or more surface features and/or waveguide width alterations may be disposed between the inner and outer cover members to create a waveguide having a unique RF response signature. In other embodiments, the waveguide may be configured with a plurality of input/output ports, thus enabling differential signal comparison of the RF response of the waveguide.

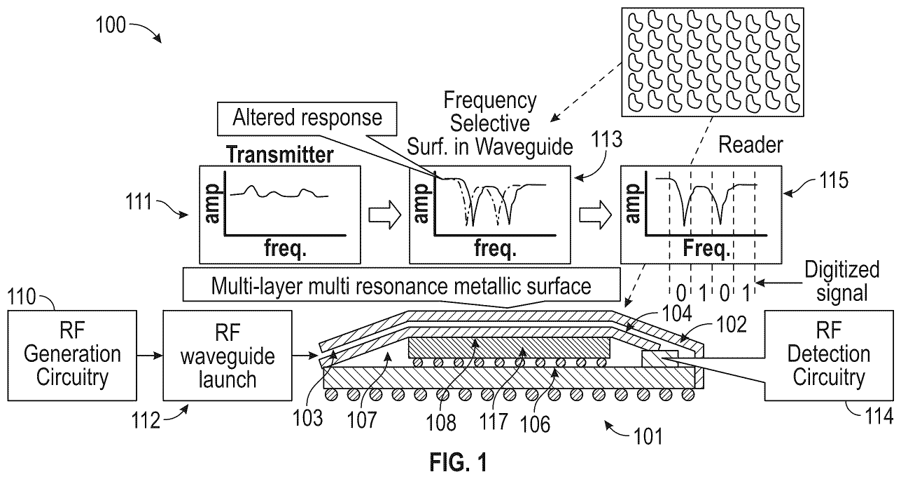

FIG. 1 illustrates a broadband intrusion detection system 100 according to embodiments of the present disclosure. The system 100 includes an asset protection device 101 that, in one embodiment, includes an outer cover member 102 disposed on a printed circuit board (PCB) 106. In at least one embodiment, the asset protection device also includes an inner cover member 104 disposed adjacent, and spaced apart from, the outer cover member 102, and also disposed on the PCB 106, generally between the outer cover member 102 and the PCB 106. The inner cover member 104 is dimensioned to provide a protected volume space 107 between a bottom surface of the inner cover member 104 and a top surface of the PCB 106, as illustrated. One or more circuit assets, e.g., chipsets 108 (e.g., integrated circuit(s), ASIC(s), memory units, etc.) may be disposed within the protected volume 107, and may be coupled to the PCB 106 via one or more solder joints, vias, etc., as is well known. By way of example, the inner 104 and outer 102 cover members may be formed of highly conductive metal material, such as, aluminum-clad copper.

An RF waveguide 103 is defined between the inner 104 and outer 102 cover members. As will be described in greater detail below, the RF waveguide 103 provides intrusion detection for intrusion events into the protected volume 107. An intrusion event, as used herein, may include, for example, a physical attack on the structure of the inner/outer cover members 102/104, for example, a puncture in the inner and/or outer cover members 102/104, a forced removal of the inner and/or outer cover member 104/102, etc. Such a physical attack may be intended to target the one or more circuits 108, for example, an attack on the front end-of-line of the silicon layer(s) of the circuits 108.

The system 100 also includes RF generation circuitry 110, which may be embodied as broadband RF “noise” generation circuitry generally configured to generate an RF signal over a selected frequency range, as illustrated by the inset graph 111. In example embodiments, the frequency range may include, for example, 15 GHz to 40 GHz. Of course, other frequency ranges may be selected, based on, for example, the overall size of the waveguide 103, overall geometry of the waveguide 103, and/or other considerations such as a frequency range having the largest gain, etc. An RF waveguide launch structure 112 may be included and generally configured to “launch” an RF signal into the waveguide 103, which may include, for example, a coaxial launch pin connecting an RF transmission line on the PCB to the internal conducting surfaces of the waveguide. The system also includes RF detection circuitry 114 generally configured to detect an RF signal response based on the RF signal generated by the RF generation circuitry 110 and the waveguide 103. In some embodiments, the RF generation circuitry 110, RF launch structure 112 and/or the RF detection circuitry 114 may be disposed within the protected volume 107.

Upon manufacture of the inner and outer cover member 102/104 and coupling of the inner and outer cover member 102/104 to the PC board 106, the RF generation circuitry 110 and RF detection circuitry 114 may be used to determine an initial, original “signature” of the RF response of the waveguide 103. The original “signature” RF response may be stored in memory, etc. associated with the RF detection circuitry 114 (and/or other circuitry). The original RF response signature is illustrated by the inset graph 113. The RF detection circuitry 114 may also include A/D converter circuitry to convert RF response signals in the waveguide 103 to a digital value (which may have a selected sampling frequency and/or bit depth depending on, for example, a desired resolution of the digital signal, the frequency range of the RF signal, etc.). A sample RF response is illustrated in the inset graph 115 which indicates frequency subbands of the RF spectrum digitized to create a signature.

As will be described in greater detail below, once the system 100 is deployed and in use, the original “signature” of the RF response of the waveguide 103 may be compared to an RF response taken periodically and/or continuously (i.e., “run time” RF response) to determine if the run time RF response differs from the original RF response signature, which may be indicative of an intrusion event associated with the inner and/or outer cover members 102/104. To that end, the RF detection circuitry 114 also includes comparator circuitry generally configured to compare the original RF response signature to the run time RF response(s).

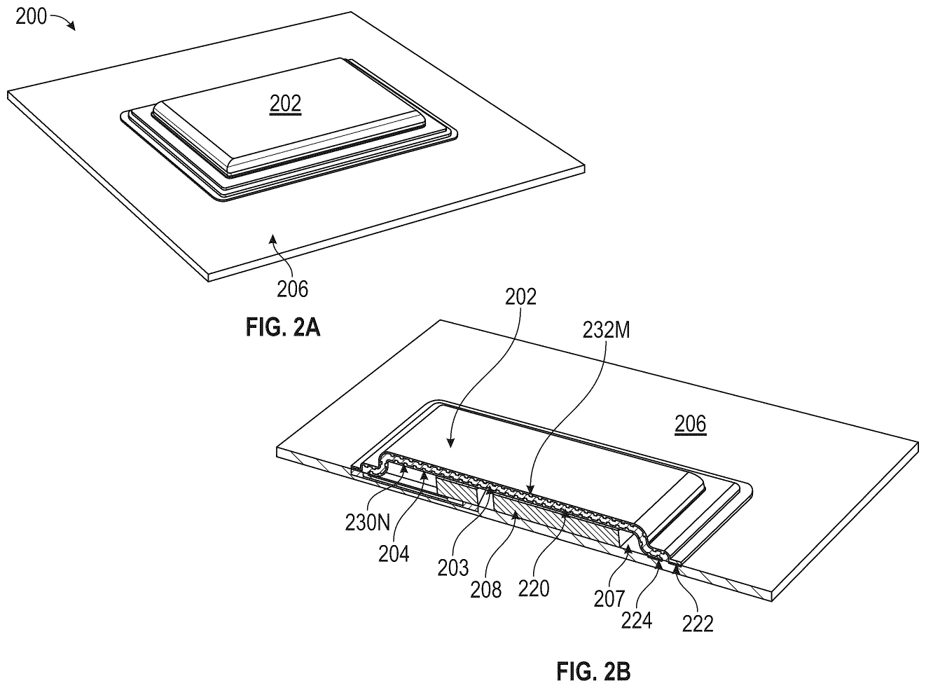

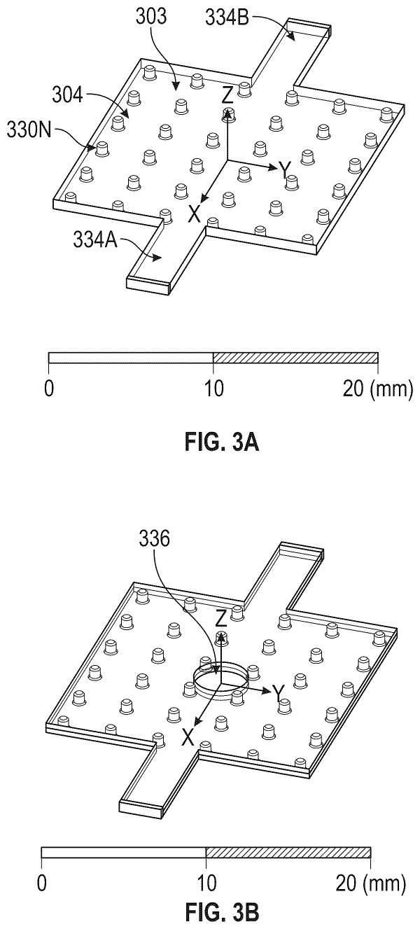

FIG. 2A illustrates an assembled view of an intrusion detection system 200 according to one embodiment of the present disclosure. As illustrated in FIG. 2A, the system 200 includes the outer cover 202 coupled to a PCB 206. FIG. 2B illustrates a cross-sectional view of the system 200. As illustrated in cross section, the system includes the spaced-apart inner 204 and outer 202 cover members, where the inner cover member 202 defines a protected volume 207 within which one or more circuits 208 are securely disposed. In some embodiments, and depending on a desired RF response, the waveguide 203 defined between the outer cover member 204 and inner cover member 202 may include dielectric material 220, for example, polyamide or diamond epoxy. As illustrated in FIGS. 2A and 2B, the inner and outer cover members 202/204 may be formed as unitary structures and securely coupled to the PCB 206 around the periphery, as shown at 224 and 222, respectively. The surface mount soldered connection of the system to the PCB 206 will shield RF signals from entering the system or escaping the internal RF circuit. By creating a connection that is integral to the RF circuit, disruptions to the continuous connection of the system will have a corresponding detectable change in internal resonance. For areas not sensitive to RF leakage, other common methods of attachment may be employed, should soldering of the full perimeter prove problematic. In this embodiment, the RF generation circuitry and RF detection circuitry may be housed within the protected volume 207.

To provide a unique RF response “signature”, the inner cover member 204 may include a plurality of surface features/ridges 230N formed on the top surface of the inner cover member 204, i.e., facing the bottom surface of the outer cover member 202. The surface features/ridges 230N operate to cause a varying width of the waveguide 203, which may cause a unique RF response signature and may also cause significant disruption of a run time RF response of the waveguide 203 in the event of an intrusion event into the cover 202 and/or 204, thus providing a larger discrepancy between the RF response signature and an RF response when an intrusion event occurs. In some embodiments, the bottom surface of the outer cover member 202 may also include a plurality of surface features/ridges 230N formed on the bottom surface of the outer cover member 202, i.e., facing the top surface of the inner cover member 204. In some embodiments, the surface features 230N may be disposed in a “sub-wavelength” pattern (e.g., each surface feature is a half wavelength apart from other surface features, quarter wavelength apart, etc.), which may be defined as a “metasurface” to manipulate RF waves. In other embodiments, the surface features 230N may be disposed in a random or semi-random pattern.

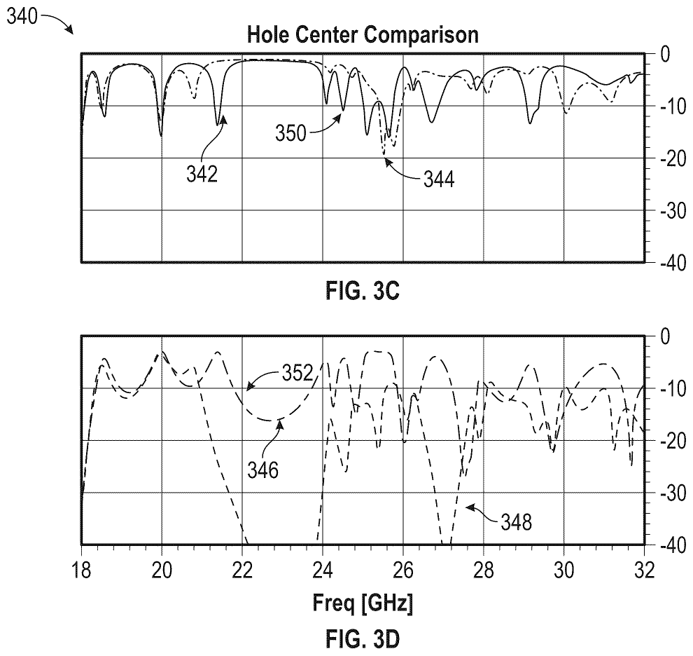

FIGS. 3A-3D illustrate example output power simulations of a waveguide structure and intrusion event according to one embodiment of the present disclosure. FIG. 3A illustrates an inner cover member 304 defining, in part, an example waveguide 303 according to one embodiment. In this embodiment, the outer cover member (as shown in FIG. 2) is omitted for clarity. In this embodiment, the top surface of the inner cover member 304 includes a plurality of surface features, one of which is shown at 330N. Each of the plurality of surface features 330N generally include an extension member that is formed between the inner cover member 304 and the outer cover member, within the waveguide 303. In this example, the plurality of surface features 330N are disposed as a square grid that generally aligns with the edges of the cover member 304. I/O ports 334A and 334B are included to provide coupling to RF generation circuitry and RF detection circuitry (not shown in these Figures). The geometry of the ports 334A and 334B are exaggerated for simulation purposes, and in embodiments the ports 334A and 334B may be formed of appropriate geometries for a given frequency range, RF signal strength, etc. In addition, the location of ports 334A and 334B are illustrated at opposite ends of the cover member 304, however, the location of the ports 334A and 334B may be selected based on, for example manufacturing convenience, intended RF response(s), etc.

FIG. 3B illustrates an intrusion event (e.g., bore hole 336) formed approximately in the center of the inner cover member 304. FIG. 3C illustrates a RF graph 340 of an initial signature RF response plot 342 (i.e., the initial RF response of the waveguide 303 of FIG. 3A) overlaid with an RF response plot 344 after the intrusion event shown in FIG. 3B, where the RF responses are simulated at a single port 334A (i.e., RF input and output is taken at the same port 334A) over a frequency sweep of approximately 18 GHz. to 32 GHz. Differences between the initial signature RF response and the RF response after the intrusion event, for example at region 350, may be used to determine an intrusion event (via, RF detection circuitry as described above). FIG. 3D illustrates a RF graph 340 of an initial signature RF response plot 346 (i.e., the initial RF response of the waveguide 303 of FIG. 3A) overlaid with an RF response plot 348 after the intrusion event shown in FIG. 3B, where the RF responses are simulated between port 334A and 334B (i.e., RF input at 334A and RF output is taken at port 334B), over a frequency sweep of approximately 18 GHz. to 32 GHz. Differences between the initial signature RF response and the RF response after the intrusion event, for example at region 352, may be used to determine an intrusion event (via, RF detection circuitry as described above). Of course, in other embodiments, the outer cover member may include the surface features as described above.

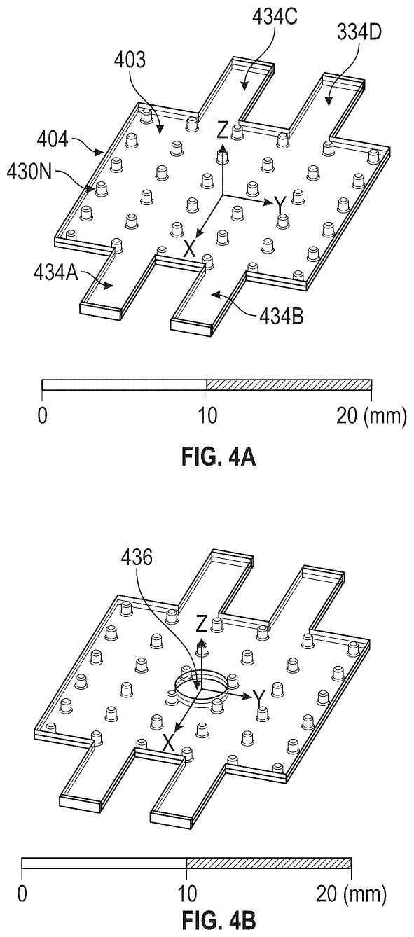

FIGS. 4A-4E illustrate example simulations of a waveguide structure and intrusion event according to another embodiment of the present disclosure. FIG. 4A illustrates the waveguide structure showing the inner cover member 404, where the metallic outer cover member is removed for clarity. In this embodiment, the top surface of the inner cover member 404 includes a plurality of surface features, one of which is shown at 430N. Each of the plurality of surface features 430N generally include an extension member that is formed between the inner cover member 404 and the outer cover member, within the waveguide 403. In this example, the plurality of surface features are disposed as a square grid that generally aligns with the edges of the cover member 404. I/O ports 434A, 434B, 434C and 434D are included to provide coupling to RF generation circuitry and RF detection circuitry (not shown in these Figures), and to enable differential signal analysis, as described below. The geometry of the ports 434A, 434B, 434C and 434D are exaggerated for simulation purposes, and in embodiments the ports 434A, 434B, 434C and 434D may be formed of appropriate geometries for a given frequency range, RF signal strength, etc. In addition, the location of ports 434A, 434B, 434C and 434D are illustrated at opposite ends of the cover member 404, however, the location of the ports 434A, 434B, 434C and 434D may be selected based on, for example manufacturing convenience, intended RF response(s), etc. FIG. 4B illustrates an intrusion event (e.g., bore hole 436) formed approximately in the center of the inner cover member 404 of the waveguide structure. FIG. 4C illustrates a RF graph 440 of an initial signature RF response plot 442 (i.e., the initial RF response of the waveguide 403 of FIG. 4A) overlaid with an RF response plot 444 after the intrusion event shown in FIG. 4B, where the RF responses are simulated at a single port 434A (i.e., RF input and output is taken at the same port 334A) over a frequency sweep of approximately 18 GHz. to 32 GHz. Differences between the initial signature RF response and the RF response after the intrusion event, for example at region 450, may be used to determine an intrusion event (via, RF detection circuitry as described above).

FIG. 4D illustrates a plot of differential output power for the RF response of the cover 404 of FIGS. 4A and 4B. In particular, the plots of FIG. 4D illustrate a differential RF output power graph of an initial differential signature RF response plot 464 (i.e., the initial RF response of the waveguide 403 of FIG. 4A) overlaid with an initial differential RF response plot 462 after the intrusion event shown in FIG. 4B. In this example, the initial differential RF response plot 464 is measured as: (Port434C/Port434A+Port434C/Port434B)−(Port434D/Port434A+Port434D/Port434B), representing input/output pairs. Differences between the initial signature RF response and the RF response after the intrusion event, for example at region 466, may be used to determine an intrusion event (via, RF detection circuitry as described above).

While the foregoing plots illustrate simulation examples of output power RF responses of the waveguide 403 (defined, in part, by the inner cover member 404), in some embodiments, differential phase information may be used instead of, or in addition to differential output power. Accordingly, FIG. 4E illustrates a plot of differential output phase for the RF response of the cover 404 of FIGS. 4A and 4B. In particular, the plots of FIG. 4E illustrate a differential RF output phase graph of an initial differential signature RF response plot 472 (i.e., the initial RF response of the waveguide 403 of FIG. 4A) overlaid with a differential phase RF response plot 474 after the intrusion event shown in FIG. 4B. In this example, the initial differential RF response plot 472 is measured as: (Port434C/Port434A)−(Port434D/Port434A), representing input/output pairs. Differences between the initial signature RF response and the RF response after the intrusion event, for example at region 476, may be used to determine an intrusion event (via, RF detection circuitry as described above). For differential phase analysis, the RF detector circuitry (described above) may be configured to detect and/or derive phase information of the RF response(s) and compare initial phase responses of the waveguide to run-time phase responses of the waveguide.

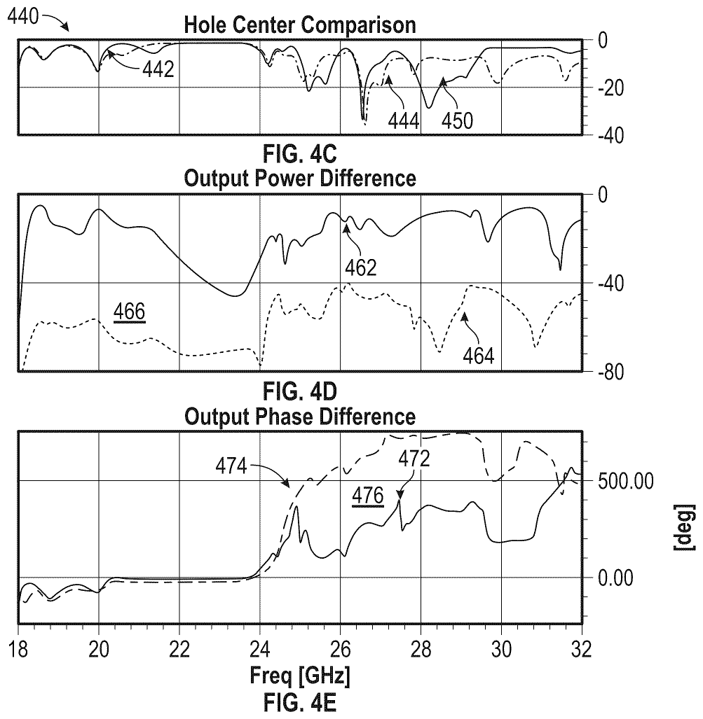

FIG. 5 illustrates an inner cover member 504 defining an example waveguide 503 according to another embodiment. In this embodiment, the outer cover member (as shown in FIG. 2) is omitted for clarity. In this embodiment, the top surface of the inner cover member 504 includes a plurality of surface features, one of which is shown at 530N. Each of the plurality of surface features 530N generally include an extension member that is formed between the inner cover member 504 and the outer cover member, within the waveguide 503. In this example, the plurality of surface features 530N are disposed to define a “maze” or “racetrack” pattern 560, as illustrated.

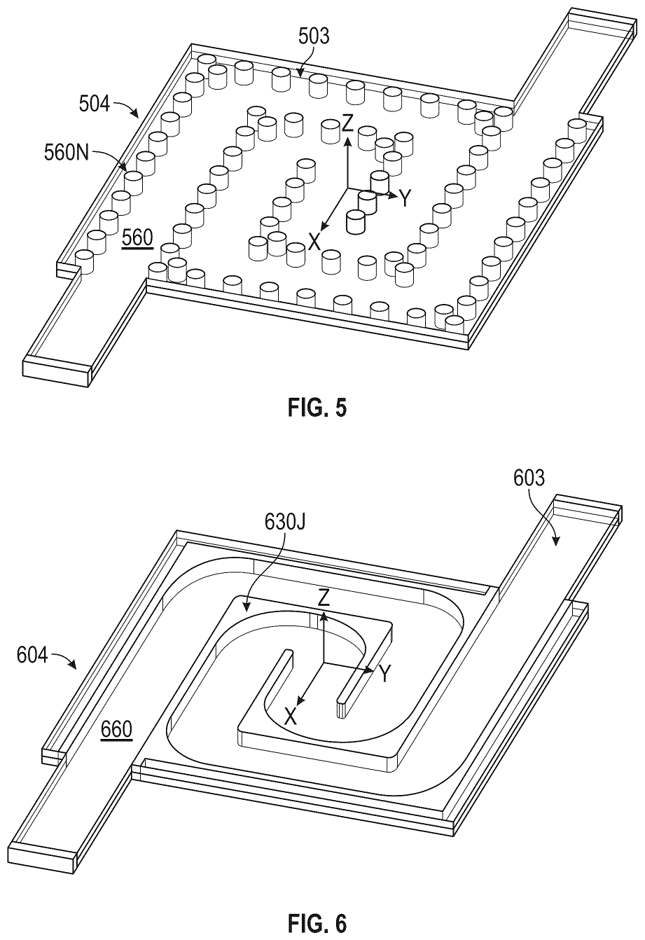

FIG. 6 illustrates an inner cover member 604 defining an example waveguide 603 according to another embodiment. In this embodiment, the outer cover member (as shown in FIG. 2) is omitted for clarity. In this embodiment, the top surface of the inner cover member 604 includes a plurality of surface features in the form of ridges, one of which is shown at 630J. Each of the plurality of ridges 630j generally include an extension member that is formed between the inner cover member 604 and the outer cover member, within the waveguide 603. In this example, the plurality of ridges 630J are disposed to define a “maze” or “racetrack” pattern 660, as illustrated.

The foregoing examples of surface features/ridges, as described with reference to FIGS. 2A-2B, 3A-3D, 4A-4E, 5 and 6, are generally shown as a uniform pattern of surface features disposed on the inner and/or outer cover members. In other embodiments, the surface features may be disposed on the inner and/or outer cover members in other patterns, for example, hexagonal pattern, circular pattern, etc. The selected pattern may generate a unique RF response “signature” of the RF waveguide. To that end, the pattern may be selected as a random or pseudo-random pattern, which may be the result of “loose” manufacturing tolerances. In addition, the shape and/or size of the surface features may be randomly selected. In some embodiments, the RF response signature of the waveguide may be used, for example, as a cryptographic key, where random deviations in geometry of surface features operate to contribute to the generation of a unique and undiscoverable cryptographic key.

The embodiments described above include inner and outer cover members disposed on a PCB. However, such embodiments may be insufficient for some applications to detect a “bottom-up” intrusion event through the PCB. Accordingly, in another embodiment, the inner and outer cover members may be disposed to completely surround the protected volume, for example, the inner and outer cover members extend through the PCB and form an intrusion barrier from any position.

In other embodiments, the system may include a single cover member (i.e., the inner or outer cover member is omitted), and the waveguide is defined between the single cover member and the PCB and/or defined within the protected volume. In still other embodiments, three or more cover members may be used, each having a unique RF waveguide structure therebetween.

In any of the embodiments described herein, the RF detection circuitry may be configured to perform specified actions if an intrusion event is detected. For example, upon a detected intrusion event, the RF detection circuitry may be configured to control communications circuitry (not shown) to generate an alert message to a remote location (e.g., system administrator, etc.). As another example, upon a detected intrusion event, the RF detection circuitry may be configured to perform a memory wipe (e.g., deleting any data and/or instructions from memory associated with the circuitry) and/or discontinue power delivery to the circuit components within the protected volume.

In any of the embodiments described herein, to account for variations in temperature and/or external RF noise sources which may affect the run-time RF response, the RF detection circuitry may be configured to enable a threshold for use in comparing the initial RF response to a run-time RF response. Such a threshold may represent, for example, an error margin (e.g., 2%, 5%, etc.) of permissible variances between the initial RF response and a run-time response before an intrusion event is considered assumed.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Any of the operations described herein may be implemented in a system that includes one or more non-transitory storage devices having stored therein, individually or in combination, instructions that when executed by circuitry perform the operations. Such instructions may embodied as, for example, machine code, and/or “higher level” implementations such as software programing, application (app) programming, etc. “Circuitry”, as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The storage device includes any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device. Also, it is intended that operations described herein may be distributed across a plurality of physical devices, such as processing structures at more than one different physical location.

Accordingly, in one embodiment the present disclosure provides a broadband intrusion detection system for volume and asset protection. The system includes a base unit for coupling one or more circuit elements; an inner cover member attached to the base unit, the inner cover member defining a protected volume between the inner cover member and the base unit; an outer cover member disposed over, and spaced-apart from, the inner cover member, and attached to the base unit; wherein a space between the inner cover member and the outer cover member defines a radio frequency (RF) waveguide. The system also includes RF generation circuitry coupled to the RF waveguide and configured to generate an RF signal into the RF waveguide at a selected frequency range; and RF detection circuitry coupled to the RF waveguide and configured to detect an RF response of the RF waveguide in response to the RF signal.

In another embodiment, the present disclosure provides a broadband intrusion detection system for volume and asset protection The system includes a base unit for coupling one or more circuit elements; an inner cover member attached to the base unit, the inner cover member defining a protected volume between the inner cover member and the base unit; an outer cover member disposed over, and spaced-apart from, the inner cover member, and attached to the base unit; wherein a space between the inner cover member and the outer cover member defines a radio frequency (RF) waveguide. The system also includes RF generation circuitry coupled to the RF waveguide and configured to generate an RF signal into the RF waveguide at a selected frequency range; and RF detection circuitry coupled to the RF waveguide and configured to detect an RF response of the RF waveguide in response to the RF signal. The RF detection circuitry further configured to determine an initial RF response of the RF waveguide and to determine at least one run-time RF response of the RF waveguide; the RF detection circuitry further configured to compare the initial RF response of the RF waveguide to the at least one run-time RF response of the RF waveguide; wherein a difference between the initial RF response of the RF waveguide to the at least one run-time RF response is indicative of an intrusion event into the inner and/or outer cover members.

In another embodiment, the present disclosure provides a broadband intrusion detection system for volume and asset protection. The system includes a base unit for coupling one or more circuit elements; a cover member attached to the base unit, the cover member defining a protected volume between the cover member and the base unit; wherein the protected volume defines a radio frequency (RF) waveguide. The system also includes RF generation circuitry coupled to the RF waveguide and configured to generate an RF signal into the RF waveguide at a selected frequency range; and RF detection circuitry coupled to the RF waveguide and configured to detect an RF response of the RF waveguide in response to the RF signal.

In another embodiment, the present disclosure provides a broadband intrusion detection system for volume and asset protection. The system includes a base unit for coupling one or more circuit elements; a cover member attached to the base unit, the cover member defining a protected volume between the cover member and the base unit; wherein the protected volume defines a radio frequency (RF) waveguide. The system also includes RF generation circuitry coupled to the RF waveguide and configured to generate an RF signal into the RF waveguide at a selected frequency range; and RF detection circuitry coupled to the RF waveguide and configured to detect an RF response of the RF waveguide in response to the RF signal. The RF detection circuitry further configured to determine an initial RF response of the RF waveguide and to determine at least one run-time RF response of the RF waveguide; the RF detection circuitry further configured to compare the initial RF response of the RF waveguide to the at least one run-time RF response of the RF waveguide; wherein a difference between the initial RF response of the RF waveguide to the at least one run-time RF response is indicative of an intrusion event into the inner and/or outer cover members.

In yet another embodiment, the present disclosure provides a broadband intrusion detection system for volume and asset protection. The system includes an inner cover member defining a protected volume; an outer cover member disposed over, and spaced-apart from, the inner cover member, wherein a space between the inner cover member and the outer cover member defines a radio frequency (RF) waveguide. The system also includes RF generation circuitry coupled to the RF waveguide and configured to generate an RF signal into the RF waveguide at a selected frequency range; and RF detection circuitry coupled to the RF waveguide and configured to detect an RF response of the RF waveguide in response to the RF signal.

In yet another embodiment, the present disclosure provides a broadband intrusion detection system for volume and asset protection. The system includes an inner cover member defining a protected volume; an outer cover member disposed over, and spaced-apart from, the inner cover member, wherein a space between the inner cover member and the outer cover member defines a radio frequency (RF) waveguide. The system also includes RF generation circuitry coupled to the RF waveguide and configured to generate an RF signal into the RF waveguide at a selected frequency range; and RF detection circuitry coupled to the RF waveguide and configured to detect an RF response of the RF waveguide in response to the RF signal. The RF detection circuitry further configured to determine an initial RF response of the RF waveguide and to determine at least one run-time RF response of the RF waveguide; the RF detection circuitry further configured to compare the initial RF response of the RF waveguide to the at least one run-time RF response of the RF waveguide; wherein a difference between the initial RF response of the RF waveguide to the at least one run-time RF response is indicative of an intrusion event into the inner and/or outer cover members.

In still other embodiments the system may also include one or more surface features disposed on the inner cover member and/or outer cover member and protruding into the space between the inner cover member and the outer cover member; the one or more surface features configured to cause a unique RF response of the RF waveguide.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A broadband intrusion detection system for volume and asset protection, comprising:
a base unit for coupling one or more circuit elements;
an inner cover member attached to the base unit, the inner cover member defining a protected volume between the inner cover member and the base unit;
an outer cover member disposed over, and spaced-apart from, the inner cover member, and attached to the base unit; wherein a space between the inner cover member and the outer cover member defines a radio frequency (RF) waveguide;
RF generation circuitry coupled to the RF waveguide and configured to generate an RF signal into the RF waveguide at a selected frequency range; and
RF detection circuitry coupled to the RF waveguide and configured to detect an RF response of the RF waveguide in response to the RF signal.

2. The system of claim 1, wherein the RF detection circuitry further configured to determine an initial RF response of the RF waveguide and to determine at least one run-time RF response of the RF waveguide; the RF detection circuitry further configured to compare the initial RF response of the RF waveguide to the at least one run-time RF response of the RF waveguide;
wherein a difference between the initial RF response of the RF waveguide to the at least one run-time RF response is indicative of an intrusion event into the inner and/or outer cover members.

3. The system of claim 1, further comprising one or more surface features disposed on the inner cover member and/or outer cover member and protruding into the space between the inner cover member and the outer cover member; the one or more surface features configured to cause a unique RF response of the RF waveguide.

4. The system of claim 3, wherein the one or more surface features being disposed on the inner cover member and/or outer cover member in a uniform pattern.

5. The system of claim 3, wherein the one or more surface features being disposed on the inner cover member and/or outer cover member in a random pattern.

6. The system of claim 1, wherein the base unit is a PC board.

7. The system of claim 1, wherein the inner cover member and the outer cover member are formed of metal.

8. The system of claim 1, wherein the RF detector circuitry is configured to detect an RF output power response of the RF waveguide.

9. The system of claim 1, wherein the RF detector circuitry is configured to detect an RF phase response of the RF waveguide.

10. The system of claim 1, further comprising an input/output port coupled to the RF waveguide, and wherein the RF generation circuitry and the RF detection circuitry are coupled to the input/output port.

11. The system of claim 1, further comprising an input port coupled to the RF waveguide and to the RF generation circuitry, and an output port coupled to the RF waveguide and to the RF detection circuitry.

12. The system of claim 1, further comprising a pair of input ports coupled to the RF waveguide and to the RF generation circuitry, and a pair of output ports coupled to the RF waveguide and to the RF detection circuitry; wherein the RF detection circuitry configured to determine a differential RF response of the RF waveguide using the pair of input ports and the pair of output ports.

13. A broadband intrusion detection system for volume and asset protection, comprising:
a base unit for coupling one or more circuit elements;
an inner cover member attached to the base unit, the inner cover member defining a protected volume between the inner cover member and the base unit;
an outer cover member disposed over, and spaced-apart from, the inner cover member, and attached to the base unit; wherein a space between the inner cover member and the outer cover member defines a radio frequency (RF) waveguide;
RF generation circuitry coupled to the RF waveguide and configured to generate an RF signal into the RF waveguide at a selected frequency range; and
RF detection circuitry coupled to the RF waveguide and configured to detect an RF response of the RF waveguide in response to the RF signal; wherein
the RF detection circuitry further configured to determine an initial RF response of the RF waveguide and to determine at least one run-time RF response of the RF waveguide; the RF detection circuitry further configured to compare the initial RF response of the RF waveguide to the at least one run-time RF response of the RF waveguide; wherein a difference between the initial RF response of the RF waveguide to the at least one run-time RF response is indicative of an intrusion event into the inner and/or outer cover members.

14. The system of claim 13, further comprising one or more surface features disposed on the inner cover member and/or outer cover member and protruding into the space between the inner cover member and the outer cover member; the one or more surface features configured to cause a unique RF response of the RF waveguide.

15. The system of claim 14, wherein the one or more surface features being disposed on the inner cover member and/or outer cover member in a uniform pattern.

16. The system of claim 14, wherein the one or more surface features being disposed on the inner cover member and/or outer cover member in a random pattern.

17. The system of claim 13, wherein the base unit is a PC board.

18. The system of claim 13, wherein the inner cover member and the outer cover member are formed of metal.

19. The system of claim 13, wherein the RF detector circuitry is configured to detect an RF output power response of the RF waveguide.

20. The system of claim 13, wherein the RF detector circuitry is configured to detect an RF phase response of the RF waveguide.

21. The system of claim 13, further comprising an input/output port coupled to the RF waveguide, and wherein the RF generation circuitry and the RF detection circuitry are coupled to the input/output port.

22. The system of claim 13, further comprising an input port coupled to the RF waveguide and to the RF generation circuitry, and an output port coupled to the RF waveguide and to the RF detection circuitry.

23. The system of claim 13, further comprising a pair of input ports coupled to the RF waveguide and to the RF generation circuitry, and a pair of output ports coupled to the RF waveguide and to the RF detection circuitry; wherein the RF detection circuitry configured to determine a differential RF response of the RF waveguide using the pair of input ports and the pair of output ports.
